(19) United States
(12) Patent Application Publication
(10) Pub. No.: US 2010/0214221 A1
(43) Pub. Date: Aug. 26, 2010

(54) MOUSE

(75) Inventors: Kyungno LEE, Seoul (KR); Il-Kweon Joung, Seongnam-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/568,388

(22) Filed: Sep. 28, 2009

(30) Foreign Application Priority Data
Feb. 24, 2009 (KR) 10-2009-0015319

(51) Int. Cl. G09G 5/08

(52) U.S. Cl. 345/163

(57) ABSTRACT

A mouse is disclosed. In accordance with an embodiment of the present invention, the mouse for inputting information to a computer including a monitor can include a touch detector coupled to one surface of a case, a driver, which vibrates the touch detector in a direction parallel to one surface of the touch detector such that a tactile feel of a surface of the touch detector is changed, and a controller, which controls an operating frequency of the driver. Thus, the mouse can provide the user with a better sensation that the tactile feel changes at the portion that the user touches.

### CROSS-REFERENCE TO RELATED APPLICATIONS

This application claims the benefit of Korean Patent Application No. 10-2009-0015319, filed with the Korean Intellectual Property Office on Feb. 24, 2009, the disclosure of which is incorporated herein by reference in its entirety.

### BACKGROUND

1. Technical Field

The present invention relates to a mouse.

2. Description of the Related Art

A mouse is an input device that functions by detecting two-dimensional motion relative to its supporting surface. The mouse's motion translates into the motion of a pointer on an image display of a computer. Physically, a mouse can include a case, a cord being connected to the main body of a computer and a position detector detecting the movement of the case.

If the mouse is connected to a computer, a pointer is displayed on the image display. Here, the user moves the case of the mouse, and the position detector detects the movement of the case, allowing the user to move the pointer.

If the pointer lies on an icon that is displayed on the image display, the user can press a mouse button formed on the upper side of the case, to execute the functions related to the icon or to drag the selected icon.

As such, the user may maneuver the mouse to input information, such as executing a command to a computer. However, since the manipulation of the mouse is visually recognized only, the mouse does not provide a sufficient sensory feel.

### SUMMARY

The present invention provides a mouse capable of providing feedback in the form of a tactile feel in response to a user maneuvering the mouse.

An aspect of the present invention provides a mouse, which inputs information to a computer including an image display, that includes a touch detector coupled to one surface of a case, a driver, which vibrates the touch detector in a direction parallel to one surface of the touch detector such that a tactile feel of a surface of the touch detector is changed, and a controller, which controls an operating frequency of the driver.

Here, the operating frequency of the driver can be within a range of an ultrasonic waves and can be above an audible frequency range. The driver can include a piezoelectric component, and can be coupled to one side of the touch detector. Also, the touch detector can include a touch panel.

The controller can control the driver such that the driver vibrates the touch detector at different frequencies in accordance with a touched position of the touch detector, and can partition a portion of the touch detector into a virtual tactile area. The controller can also control the driver such that the driver vibrates the touch detector at different frequencies depending on whether or not a touched position of the touch detector is within the tactile area.

The controller can partition a portion of the image display into a virtual image detecting area, in which the virtual image detecting area is moved according to a movement of the mouse and accommodates a pointer displayed on the image display.

Here, if an icon is displayed on the image display, the controller can partition a portion of the touch detector into the tactile area in accordance with a position of the icon being accommodated within the image detecting area.

If a scrollbar is displayed on the image display, the controller can partition a portion of the touch detector into the tactile area discontinuously along an extending direction of the scrollbar, in which the scrollbar is accommodated within the image detecting area.

The pointer can be operated in accordance with a touch on the touch detector.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a perspective view illustrating a mouse in accordance with an embodiment of the present invention.

FIG. 2 is a conceptual diagram illustrating a mouse classified into functional units in accordance with an embodiment of the present invention.

FIGS. 3 and 4 are plan views illustrating a modification of a touch detector that is applicable to a mouse in accordance with an embodiment of the present invention.

FIGS. 5 and 6 are conceptual diagrams illustrating the operating principle of a mouse in accordance with an embodiment of the present invention.

FIGS. 7 and 8 are front-elevational views illustrating an operation of a monitor according to an operation of a mouse in accordance with an embodiment of the present invention.

FIG. 9 is a plan view illustrating a touch detector of a mouse in accordance with an embodiment of the present invention.

FIG. 10 is a front-elevational view illustrating an operation of a monitor according to an operation of a mouse in accordance with an embodiment of the present invention.

FIG. 11 is a plan view illustrating a touch detector of a mouse in accordance with an embodiment of the present invention.

### DETAILED DESCRIPTION

The features and advantages of this invention will become apparent through the below drawings and description.

A mouse according to a certain embodiment of the present invention will be described below in more detail with reference to the accompanying drawings. Those components that are the same or are in correspondence are rendered the same reference numeral regardless of the figure number, and redundant descriptions are omitted.

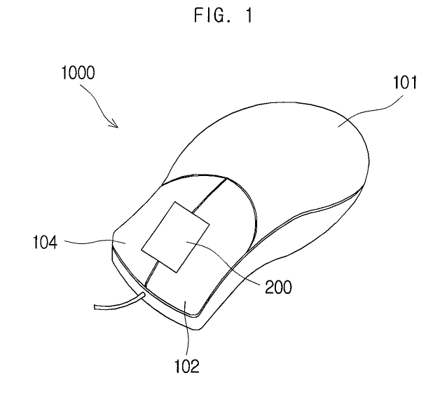

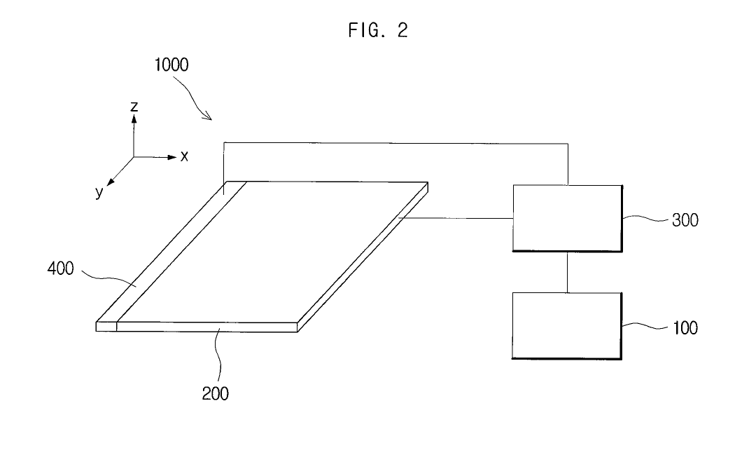

FIG. 1 is a perspective view illustrating a mouse 1000 in accordance with an embodiment of the present invention, and FIG. 2 is a conceptual diagram illustrating the mouse 1000 classified into functional units in accordance with an embodiment of the present invention.

As illustrated in FIGS. 1 and 2, the mouse 1000 in accordance with an embodiment of the present invention for inputting information to a computer including an image display can include a touch detector 200, which is coupled to one surface of a case 101, a driver 400, which vibrates the touch detector 200 in a direction parallel to one surface of the touch detector 200 such that a tactile feel of a surface of the touch detector 200 is changed, and a controller 300, which controls an operating frequency of the driver 400. Thus, the mouse 1000 can provide the user with a better sensation that the tactile feel changes at the portion that the user touches.

The case 101 is a part that forms the body of the mouse 1000, and provides a space in which the elements comprising the mouse 1000 can be housed. A first button 102 is installed on the front right side of the case 101. The user can select an icon displayed on an image display by maneuvering the first button 102.

A second button 104 is installed on the front left side of the case 101. The user can view functions related to the icon displayed on the image display by maneuvering the second button 104.

The touch detector 200 is installed on the front center part of the case 101. If the user touches a portion of the touch detector 200, the touch detector 200 can transfer information regarding the touched position to the controller 300, which will be described later.

Moreover, like the first button 102 described above, the user can select an icon displayed on the image display or execute the functions thereof by touching the touch detector 200. By disposing a sensor, which responds to the pressure applied on the surface thereof, in a pattern of grids, the touch detector 200 can detect the coordinate of the touched position.

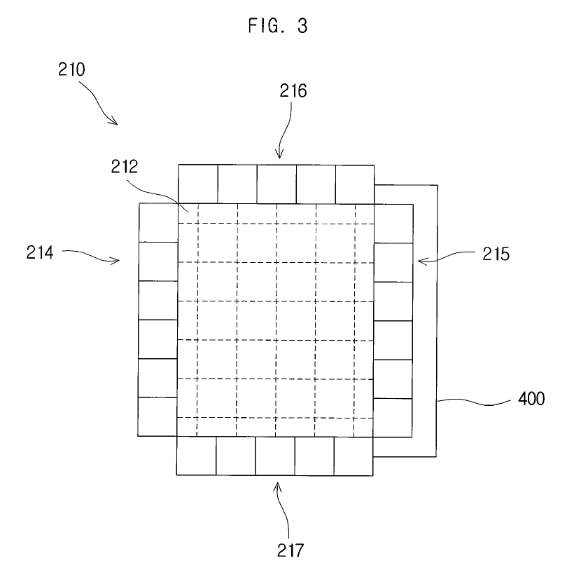

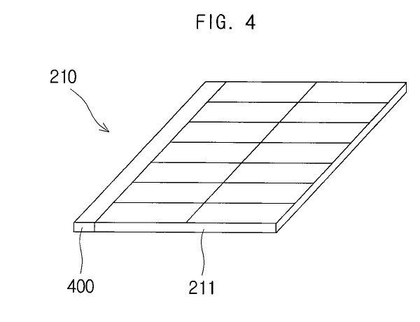

FIGS. 3 and 4 are plan views illustrating a modification of the touch detector 200 that is applicable to the mouse 1000 in accordance with an embodiment of the present invention. The touch detector 200 can be implemented in a variety of forms. For example, as the example shown in FIG. 3, the touch detector 200 can be implemented as an optical sensor module 210, in which light emitting units 214 and 216 are disposed on one side of a touch surface 212 and light receiving units 215 and 217 are disposed on the other side of the touch surface 212.

Also, like the example shown in FIG. 4, the optical sensor module 210, i.e., the touch detector, can be implemented in such a way that a plurality of pressure-sensitive materials 211, such as quantum tunneling composites (QTCs) or force sensitive resistance (FSR), are disposed in a pattern of grids. Here, the driver 400, which will be described later, can be coupled to one side of the touch surface 212, or to one side of the pressure-sensitive materials 211.

As illustrated in FIG. 2, the driver 400 can vibrate the touch detector 200 in a direction parallel to one surface of the touch detector 200 such that a tactile feel of the surface of the touch detector 200 is changed.

The driver 400, which may include a piezoelectric component, for example, can be formed in the shape of a bar and can be coupled to one side of the touch detector 200. The piezoelectric component can implement various forms of high-frequency vibrations according to the direction of polarity. In the example shown in FIG. 1, the piezoelectric component can vibrate the touch detector 200 in the direction of the x-axis.

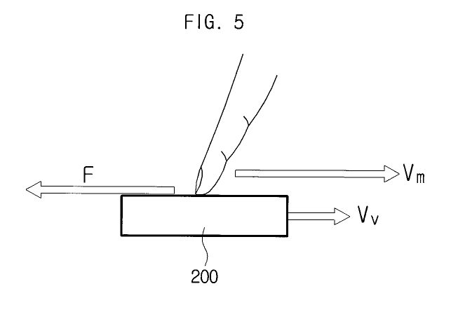

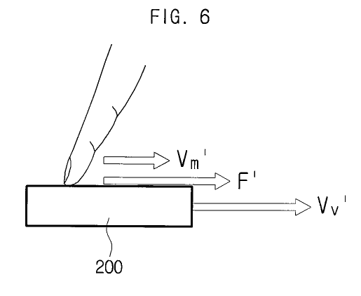

FIGS. 5 and 6 are conceptual diagrams illustrating the operating principle of the mouse 1000 in accordance with an embodiment of the present invention. As illustrated in FIG. 5, in case the user touches the touch detector 200 and drags his or her finger on the touch detector 200, if the touch detector 200 is vibrated at a slower speed (Vᵥ) than the speed (Vₘ) of the user's finger movement, the user can sense, in addition to the texture of the surface of the touch detector 200, a friction (F) in the opposite direction of the finger movement.

However, as illustrated in FIG. 6, if the touch detector 200 vibrates at a faster speed (Vᵥ′) than the speed (Vₘ′) of the user's finger movement, the user can sense a friction (F′) in the same direction of the user' finger movement. In other words, the user can feel that the friction on the surface of the touch detector 200 has decreased.

Numerous receptors exist in the human skin, each receptor transferring different information to the human brain in accordance with the frequency range. Among these receptors, pacinian corpuscles sense vibrations within a frequency range of 10 to 500 Hz.

Therefore, by vibrating the touch detector 200 at a higher frequency than 500 Hz, the driver 400 can provide sensory information that is perceived by the user not as a vibration but as a change in tactile feel, caused by the reduction in friction on the surface of the touch detector 200.

The range of frequencies perceived as vibrations may vary for each user. However, if the touch detector 200 vibrates at a frequency of 1 kHz, for example, most users will perceive this as a change in tactile feel of the surface of the touch detector 200.

Also, if the frequency of the driver 400 is above the audible frequency range, i.e. above 20 kHz—within a range of an ultrasonic waves—(for example, when a piezoelectric component is used, a frequency of up to 600 kHz may be obtained), the noise caused by the vibration of the touch detector 200 may not be perceived by the user. Thus, the user can only perceive the information provided in the form of a changed tactile feel on the surface of the touch detector 200.

As illustrated in FIG. 2, the controller 300 can be electrically connected with the driver 400 and can control the operating frequency of the driver 400. The controller 300 can be electrically connected not only with the driver 400 but also with the touch detector 200 and the position detector 100. Moreover, if the mouse 1000 is installed in a computer, it shall be apparent that the controller 300 can be electrically connected to the computer.

The controller 300 can be implemented as a set of circuitry being installed inside the mouse 1000 or can be implemented as a program inside the computer, in which the mouse 1000 is installed, for controlling the operation of the mouse 1000.

The controller 300 may receive information regarding the touched position from the touch detector 200 and can control the driver 400 to vibrate the touch detector 200 at different frequencies in accordance with the touched position.

That is, if the touched position on the touch detector 200 is changed by the user's manipulation, the controller 300 can accordingly change the operating frequency of the driver 400 so as to provide the user with a sensation that the tactile feel in a particular portion of the surface of the touch detector 200 is different from the rest of the surface of the touch detector 200.

The controller 300 can control the vibration amplitude of the driver 400 not only by controlling the operating frequency but also by controlling the voltage supplied to the driver 400. The vibration amplitude of the driver 400 is a major factor, together with the operating frequency, that determines the tactile feel of the surface of the touch detector 200. Even at the same operating frequency, the user can be provided with different tactile sensations according to the magnitude of the voltage supplied.

The position detector 100 is a part that can move a pointer 40 displayed on an image display 20 by detecting the amount of movement of the mouse 1000. The position detector 100 can be implemented with, for example, a ball and a plurality of encoders that come in contact perpendicularly with the ball, or can be implemented with an optical module including a light-emitting component and a light-receiving component.

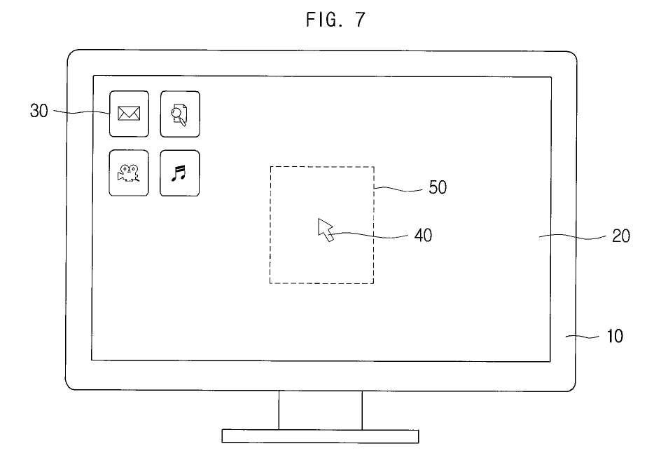

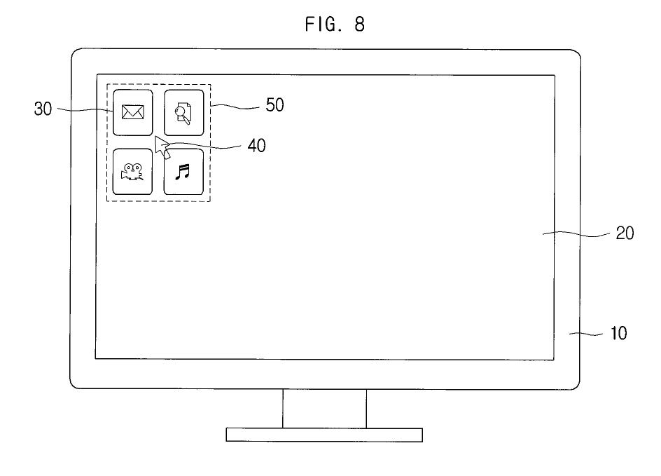

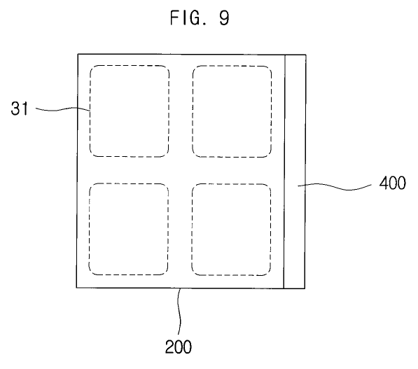

FIGS. 7 and 8 are front-elevational views illustrating an operation of a monitor 10 according to an operation of the mouse 1000 in accordance with an embodiment of the present invention, and FIG. 9 is a plan view illustrating the touch detector 200 of the mouse 1000 in accordance with an embodiment of the present invention.

As illustrated in FIGS. 7 and 8, a computer can include the monitor 10 equipped with the image display 20. The mouse 1000 can be electrically connected with the computer. When the user moves the mouse 1000, the position detector 100 detects information regarding the amount of movement of the mouse 1000 and transfers the information to the controller 300. Then, the controller 300 transfers the information to the computer, and thus the pointer 40 displayed on the image display 20 can be moved accordingly.

The controller 300 can divide a portion of the image display 20 into an image detecting area 50. The image detecting area 50 accommodates the pointer 40 at the center and can be moved with the pointer 40 in accordance with the movement of the mouse 1000.

The image detecting area 50 can detect an icon 30 or an object, for example, a scrollbar 32 displayed on the image display 20. The image detecting area 50 is an area corresponding to the touch detector 200 displayed on the image display 20.

That is, as illustrated in FIG. 8, when the icon 30 is accommodated within the image detecting area 50 while the user moves the mouse 1000, the controller 300 can divide a portion of the touch detector 200 into a tactile area 31 in accordance with the position and shape of the icon 30 accommodated within the image detecting area 50.

If the user touches the tactile area 31, the controller 300 controls the driver 400 so as to vibrate the touch detector 200, and thus the user can be provided with a different tactile feel for the surface of the tactile area 31 from the surface outside the tactile area 31.

As such, the image detecting area 50 is an area where the touch detector 200 being touched and maneuvered by the user is displayed on the image display 20, and the tactile area 31 is an area being formed on the touch detector 200 in accordance with the position and shape of the icon 30.

Therefore, this can enable the user to recognize the icon 30 not only visually through the image display 20 but also tactually through the touch detector 200.

When the user touches the surface of the touch detector 200, the touch detector 200 transfers information related to the touched position to the controller 300, and then the controller 300 transfers the information to the computer. As a result, by using the pointer 40 within the image detecting area 50, the icon 30 on which the pointer 40 is placed can be selected.

Then, if the user touches the touch detector 200 twice, the mouse 1000 transfers information related to the user's movement to the computer, allowing the computer to execute the icon 30 on which the pointer 40 is placed.

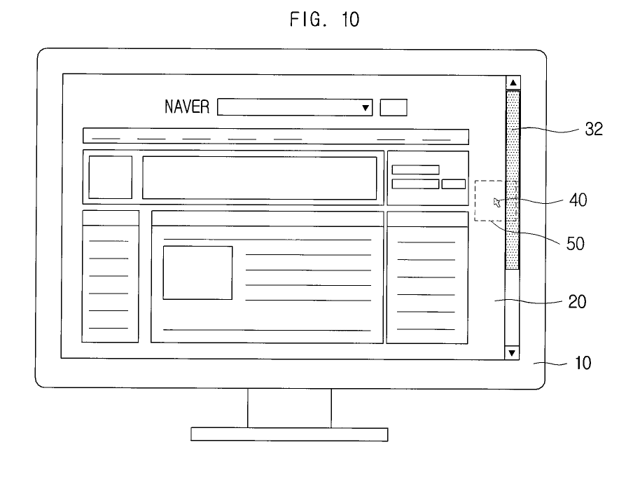

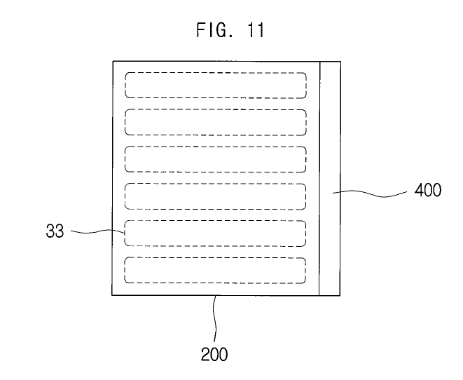

FIG. 10 is a front-elevational view illustrating an operation of the monitor 10 according to an operation of the mouse 1000 in accordance with an embodiment of the present invention, and FIG. 11 is a plan view illustrating the touch detector 200 of the mouse 1000 in accordance with an embodiment of the present invention.

As in the example illustrated in FIG. 10, if the scrollbar 32 is accommodated within the image detecting area 50, the controller 300 can form the tactile area 31 by partitioning a portion of the touch detector 200 discontinuously along an extending direction of the scrollbar 32, as illustrated in FIG. 11.

In other words, the tactile area 31 has a form in the lateral direction in which the touch detector 200 extends, and there can be a plurality of tactile areas 31 that are separated from one another and arranged in a longitudinal direction.

When the user's finger moves along the longitudinal direction on the surface of the touch detector 200, the controller 300 can control the driver 400 to vibrate the touch detector 200 only if the touching position is within the tactile area 31.

Here, the feedback related to the movement of scrolling can be supplied to the user not only visually through the image display 20 but also tactually through the touch detector 200. Therefore, the user can perceive the feedback caused by the manipulation of the mouse 1000 more concretely.

While the spirit of the invention has been described in detail with reference to a particular embodiment, the embodiment is for illustrative purposes only and shall not limit the invention. It is to be appreciated that those skilled in the art can change or modify the embodiment without departing from the scope and spirit of the invention.

As such, many embodiments other than that set forth above can be found in the appended claims.

What is claimed is:

1. A mouse configured to input information to a computer including an image display, the mouse comprising:
a touch detector coupled to one surface of a case;
a driver configured to vibrate the touch detector in a direction parallel to one surface of the touch detector such that a tactile feel of a surface of the touch detector is changed; and
a controller configured to control an operating frequency of the driver.

2. The mouse of claim 1, wherein an operating frequency of the driver is within a range of an ultrasonic waves.

3. The mouse of claim 2, wherein an operating frequency of the driver is above an audible frequency range.

4. The mouse of claim 1, wherein the driver comprises a piezoelectric component.

5. The mouse of claim 1, wherein the driver is coupled to one side of the touch detector.

6. The mouse of claim 1, wherein the touch detector comprises a touch panel.

7. The mouse of claim 1, wherein the controller controls the driver such that the driver vibrates the touch detector at different frequencies in accordance with a touched position of the touch detector.

8. The mouse of claim 7, wherein:
the controller partitions a portion of the touch detector into a virtual tactile area; and
the controller controls the driver such that the driver vibrates the touch detector at different frequencies depending on whether or not a touched position of the touch detector is within the tactile area.

9. The mouse of claim 8, wherein the controller partitions a portion of the image display into a virtual image detecting area, the virtual image detecting area being moved according to a movement of the mouse and accommodating a pointer displayed on the image display.

10. The mouse of claim 9, wherein:
an icon is displayed on the image display; and
the controller partitions a portion of the touch detector into the tactile area in accordance with a position of the icon being accommodated within the image detecting area.

11. The mouse of claim 9, wherein:
a scrollbar is displayed on the image display; and
the controller partitions a portion of the touch detector into the tactile area discontinuously along an extending direction of the scrollbar, the scrollbar being accommodated within the image detecting area.

12. The mouse of claim 9, wherein the pointer is operated in accordance with a touch on the touch detector.
